(19) United States
(12) Patent Application Publication
(10) Pub. No.: US 2021/0284819 A1
(43) Pub. Date: Sep. 16, 2021

(54) THERMOPLASTIC RESIN STRUCTURE

(71) Applicant: SUMITOMO CHEMICAL COMPANY, LIMITED, Tokyo (JP)

(72) Inventors: Shota KONISHI, Ehime (JP); Noboru KONDO, Ehime (JP)

(21) Appl. No.: 17/262,609

(22) PCT Filed: Jul. 23, 2019
(86) PCT No.: PCT/JP2019/028879

§ 371 Date: Jan. 22, 2021

(30) Foreign Application Priority Data
Jul. 26, 2018 (JP) 2018-140475

(51) Int. Cl. C08K 3/36; C08K 3/22

(52) U.S. Cl. CPC C08K 3/36; C08K 2003/2241; C08K 3/22

(57) ABSTRACT

The present invention provides a thermoplastic resin structure satisfying the following (1) and (2): (1) a content of inorganic particles in the structure is less than 0.8 parts by mass with respect to 100 parts by mass of a thermoplastic resin; and (2) an area ratio of the inorganic particles on at least one surface of the structure is 0.5% or more, the area ratio being defined by π/4×r² N/S (r=d+3σ), in which the number of inorganic particles identified from image analysis of an SEM image of the surface of the structure is N number/μm², an average circle-equivalent diameter of the particles is d μm, a standard deviation of the average circle-equivalent diameter is σ μm, and a visual field area is S μm².

### TECHNICAL FIELD

The present disclosure relates to a thermoplastic resin structure.

### BACKGROUND ART

A thermoplastic resin is widely used in various applications due to its excellent transparency, mechanical properties, and moldability.

The thermoplastic resin has been spotlighted as a substitute for glass in various applications, but durability, and particularly, scratch resistance are insufficient in the thermoplastic resin. Therefore, in order to improve the scratch resistance, a sheet having improved scratch resistance has been developed by coating a sheet formed of polymethyl methacrylate with a thermosetting resin composition containing silica (for example, Patent Document 1).

### PRIOR ART DOCUMENT

### Patent Document

Patent Document 1: JP-A-2007-510531

### SUMMARY OF THE INVENTION

### Problems to be Solved by the Invention

A thermoplastic resin structure is processed into various shapes depending on applications. However, although a plastic body having coated surfaces described in Patent Document 1 has a certain degree of scratch resistance, wrinkles or cracks may occur in the coating during processing.

An object of the present disclosure is to provide a thermoplastic resin structure having excellent scratch resistance and processability.

### Means for Solving the Problems

The present disclosure includes the following aspects.

[1] A thermoplastic resin structure satisfying the following (1) and (2):

(1) a content of inorganic particles in the structure is less than 0.8 parts by mass with respect to 100 parts by mass of a thermoplastic resin; and

(2) an area ratio of the inorganic particles on at least one surface of the structure is 0.5% or more, the area ratio being defined by π/4×r² N/S (r=d+3σ), in which the number of inorganic particles identified from image analysis of an SEM image of the surface of the structure is N number/μm², an average circle-equivalent diameter of the particles is d μm, a standard deviation of the average circle-equivalent diameter is σ μm, and a visual field area is S μm².

[2] The thermoplastic resin structure according to [1], wherein the area ratio of the inorganic particles on the at least one surface of the structure is 2% or more.

[3] The thermoplastic resin structure according to [1] or [2], wherein the inorganic particle includes at least one selected from the group consisting of a silica particle, a silica composite oxide particle, an alumina particle, a titania particle, and a glass filler.

[4] The thermoplastic resin structure according to any one of [1] to [3], wherein a haze measured according to JIS K7136 is 4% or less.

[5] The thermoplastic resin structure according to any one of [1] to [4], wherein the thermoplastic resin includes a (meth)acrylic resin.

[6] The thermoplastic resin structure according to any one of [1] to [5], wherein the thermoplastic resin structure has a single layer structure.

[7] A lamp cover including the thermoplastic resin structure according to any one of [1] to [6].

[8] A method of producing the thermoplastic resin structure according to any one of [1] to [6], the method including: allowing a mixture containing a monomer and/or a polymer and inorganic particles to stand to precipitate the inorganic particles; and performing polymerization in a state where the inorganic particles are precipitated.

### Effect of the Invention

According to the present disclosure, a thermoplastic resin structure having excellent scratch resistance and processability can be provided.

### BRIEF DESCRIPTION OF THE DRAWINGS

FIG. 1 is a view for describing a heat-bending test.

FIG. 2 is a view for describing cast polymerization.

FIG. 3 is a view for describing JIS K7136.

### MODE FOR CARRYING OUT THE INVENTION

Hereinafter, a thermoplastic resin structure of the present disclosure will be described in detail.

The thermoplastic resin structure of the present disclosure contains a thermoplastic resin.

In an aspect, the thermoplastic resin can be a transparent thermoplastic resin.

Examples of the thermoplastic resin can include a (meth)acrylic resin, a polycarbonate resin, a polyether imide resin, a polyester resin or the like, a polystyrene resin, a polyether sulfone resin, a fluororesin, an acrylonitrile-butadiene-styrene (ABS) resin, an acrylonitrile-styrene (AS) resin, polyvinyl chloride, and a polyolefin resin. The thermoplastic resin to be used can be appropriately selected depending on desired properties. The thermoplastic resins may be used alone or as a mixture of two or more thereof. A (meth)acrylic resin is preferred, and a methacrylic resin is more preferred, in terms of transparency and scratch resistance. These resins may be used alone or as a mixture of two or more thereof.

In the present specification, the term “(meth)acrylic resin” includes an acrylic resin and a methacrylic resin.

The methacrylic resin is a polymer having a monomer unit derived from a monomer having a methacrylic group.

Examples of the methacrylic resin can include a methacrylic homopolymer having only a monomer unit derived from alkyl methacrylate having an alkyl group having 1 to 4 carbon atoms; and a methacrylic copolymer having a monomer unit derived from alkyl methacrylate having an alkyl group having 1 to 4 carbon atoms in an amount of 85 wt % or more and less than 100 wt %, and another monomer unit derived from a vinyl monomer copolymerizable with the monomer unit derived from alkyl methacrylate having an alkyl group having 1 to 4 carbon atoms in an amount of more than 0 wt % and 15 wt % or less.

The “alkyl methacrylate having an alkyl group having 1 to 4 carbon atoms” is a compound represented by CH₂═CH(CH₃)COOR (R is an alkyl group having 1 to 4 carbon atoms). The vinyl monomer copolymerizable with alkyl methacrylate having an alkyl group having 1 to 4 carbon atoms is copolymerizable with alkyl methacrylate having an alkyl group having 1 to 4 carbon atoms, and is a monomer having a vinyl group.

Examples of the alkyl methacrylate having an alkyl group having 1 to 4 carbon atoms can include methyl methacrylate, ethyl methacrylate, n-propyl methacrylate, isopropyl methacrylate, n-butyl methacrylate, tert-butyl methacrylate, sec-butyl methacrylate, and isobutyl methacrylate. The alkyl methacrylate having an alkyl group having 1 to 4 carbon atoms is preferably methyl methacrylate. The alkyl methacrylates may be used alone or as a mixture of two or more thereof.

Examples of the vinyl monomer copolymerizable with alkyl methacrylate having an alkyl group having 1 to 4 carbon atoms can include methacrylic acid ester (excluding alkyl methacrylate having an alkyl group having 1 to 4 carbon atoms) such as cyclohexyl methacrylate, benzyl methacrylate, 2-ethylhexyl methacrylate, 2-hydroxyethyl methacrylate, hydroxypropyl methacrylate, or monoglycerol methacrylate; acrylic acid ester such as methyl acrylate, ethyl acrylate, propyl acrylate, butyl acrylate, 2-ethylhexyl acrylate, 2-hydroxyethyl acrylate, 2-hydroxypropyl acrylate, or monoglycerol acrylate; unsaturated carboxylic acid such as acrylic acid, methacrylic acid, maleic acid, itaconic acid, maleic anhydride, or itaconic anhydride, or an acid anhydride thereof; a nitrogen-containing monomer such as acrylamide, methacrylamide, acrylonitrile, methacrylonitrile, diacetone acrylamide, or dimethylaminoethyl methacrylate; an epoxy group-containing monomer such as allyl glycidyl ether, glycidyl acrylate, or glycidyl methacrylate; and a styrene-based monomer such as styrene or α-methylstyrene.

An example of a method of producing the methacrylic resin can include a method of polymerizing alkyl methacrylate having an alkyl group having 1 to 4 carbon atoms, and if necessary, a vinyl monomer copolymerizable with alkyl methacrylate having an alkyl group having 1 to 4 carbon atoms, by a method such as bulk polymerization, solution polymerization, suspension polymerization, or emulsion polymerization.

(Polycarbonate Resin)

In the present specification, the “polycarbonate resin” is a polycarbonate resin having a structural unit derived from a dihydroxy compound. Examples of the polycarbonate resin that can be used as the thermoplastic resin in the present disclosure can include a resin obtained by reacting a dihydroxy compound such as dihydric phenol or isosorbide with a carbonylation agent by an interfacial polycondensation method or a melt transesterification method; a resin obtained by polymerizing a carbonate prepolymer by a solid phase transesterification method; and a resin obtained by polymerizing a cyclic carbonate compound by a ring opening polymerization method.

Examples of the dihydric phenol can include hydroquinone, resorcinol, 4,4′-dihydroxydiphenyl, bis(4-hydroxyphenyl)methane, bis{(4-hydroxy-3,5-dimethyl)phenyl}methane, 1,1-bis(4-hydroxyphenyl)ethane, 1,1-bis(4-hydroxyphenyl)-1-phenylethane, 2,2-bis(4-hydroxyphenyl)propane (commonly called bisphenol A), 2,2-bis{(4-hydroxy-3-methyl)phenyl}propane, 2,2-bis{(4-hydroxy-3,5-dimethyl)phenyl}propane, 2,2-bis{(4-hydroxy-3,5-dibromo)phenyl}propane, 2,2-bis{(3-isopropyl-4-hydroxy)phenyl}propane, 2,2-bis{(4-hydroxy-3-phenyl)phenyl}propane, 2,2-bis(4-hydroxyphenyl)butane, 2,2-bis(4-hydroxyphenyl)-3-methylbutane, 2,2-bis(4-hydroxyphenyl)-3,3-dimethylbutane, 2,4-bis(4-hydroxyphenyl)-2-methylbutane, 2,2-bis(4-hydroxyphenyl)pentane, 2,2-bis(4-hydroxyphenyl)-4-methylpentane, 1,1-bis(4-hydroxyphenyl)cyclohexane, 1,1-bis(4-hydroxyphenyl)-4-isopropylcyclohexane, 1,1-bis(4-hydroxyphenyl)-3,3,5-trimethylcyclohexane, 9,9-bis(4-hydroxyphenyl)fluorene, 9,9-bis{(4-hydroxy-3-methyl)phenyl}fluorene, α,α′-bis(4-hydroxyphenyl)-o-diisopropylbenzene, α,α′-bis(4-hydroxyphenyl)-m-diisopropylbenzene, α,α′-bis(4-hydroxyphenyl)-p-diisopropylbenzene, 1,3-bis(4-hydroxyphenyl)-5,7-dimethyladamantane, 4,4′-dihydroxydiphenyl sulfone, 4,4′-dihydroxydiphenyl sulfoxide, 4,4′-dihydroxydiphenyl sulfide, 4,4′-dihydroxydiphenyl ketone, 4,4′-dihydroxydiphenyl ether, and 4,4′-dihydroxydiphenyl ester. These dihydric phenols may be used alone or in combination of two or more thereof.

Among the dihydric phenols, bisphenol A, 2,2-bis{(4-hydroxy-3-methyl)phenyl}propane, 2,2-bis(4-hydroxyphenyl)butane, 2,2-bis(4-hydroxyphenyl)-3-methylbutane, 2,2-bis(4-hydroxyphenyl)-3,3-dimethylbutane, 2,2-bis(4-hydroxyphenyl)-4-methylpentane, 1,1-bis(4-hydroxyphenyl)-3,3,5-trimethylcyclohexane, or α,α′-bis(4-hydroxyphenyl)-m-diisopropylbenzene is preferred. In particular, it is preferable that bisphenol A is used alone, or bisphenol A and at least one selected from the group consisting of 1,1-bis(4-hydroxyphenyl)-3,3,5-trimethylcyclohexane, 2,2-bis{(4-hydroxy-3-methyl)phenyl}propane, and α,α′-bis(4-hydroxyphenyl)-m-diisopropylbenzene are used in combination.

Examples of the carbonylation agent can include a carbonyl halide (such as phosgene), a carbonate ester (such as diphenyl carbonate), and a haloformate (such as dihaloformate of dihydric phenol). These dihydric phenols may be used alone or in combination of two or more thereof.

In a case where a monomer and/or a polymer that is a raw material of the thermoplastic resin is mixed with the inorganic particles, the inorganic particles are dispersed under a condition in which polymerization of the monomer and/or the polymer is not initiated, and the obtained dispersion liquid is allowed to stand, at least a part of the inorganic particles may be precipitated.

In a preferred aspect, a cup viscosity of the monomer and/or the polymer that is the raw material of the thermoplastic resin of the present disclosure is preferably 0.1 seconds or longer and 18 seconds or shorter, more preferably 0.5 seconds or longer and 15 seconds or shorter, and still more preferably 1 second or longer and 13 seconds or shorter. When the cup viscosity of the monomer and/or the polymer is shorter than 0.1 seconds, the inorganic particles are precipitated in a short time. Therefore, when the monomer and/or the polymer in which the inorganic particles are dispersed is transferred from a preparation vessel to a polymerization vessel, the inorganic particles are precipitated at a bottom of the preparation vessel. Thus, a predetermined amount of inorganic particles cannot be transferred to the polymerization vessel. When the cup viscosity of the monomer and/or the polymer is longer than 18 seconds, the inorganic particles are not precipitated in the polymerization vessel, and thus, scratch resistance of a cast plate after the polymerization deteriorates. Here, an unheated monomer and/or polymer used in cast polymerization is used as a sample, and the time required for the sample to pass through a cylinder having a truncated cone shape according to the following procedure is defined as a cup viscosity. A cylinder formed of stainless steel and having an upper surface inner diameter of 37 mm, a lower surface inner diameter of 5 mm, and a height of 65 mm is used as the cylinder having the truncated cone shape.

A specific procedure will be described below. The sample is poured into a cylindrical beaker having an inner diameter of 100 mm and a height of 110 mm until a height of a liquid level reaches 80 mm or higher, and the cylinder having the truncated cone shape is immersed to be lower than the liquid level of the sample, thereby filling the cylinder having the truncated cone shape with the sample. Thereafter, the cylinder having the truncated cone shape is pulled up vertically so that the cylinder is higher than the liquid level of the sample in the beaker. The time from the moment of pulling up until the sample in the cylinder having the truncated cone shape flows is measured and defined as a cup viscosity (unit: second).

The thermoplastic resin structure of the present disclosure contains inorganic particles. The thermoplastic resin structure of the present disclosure contains the inorganic particles, such that the thermoplastic resin structure has excellent scratch resistance.

A shape of the inorganic particle can be a substantially spherical shape, a rectangular parallelepiped shape, or a crushed shape having a plurality of corners. The shape of the inorganic particle is preferably a substantially spherical shape and more preferably a spherical shape.

An average primary particle size of the inorganic particles used in the present disclosure is 0.01 μm or more and 10 μm or less, more preferably 0.3 μm or more and 1.5 μm or less, and still more preferably 0.3 μm or more and 1.0 μm or less. The average primary particle size can be measured, for example, by a laser diffraction type particle size distribution measuring device. When the average primary particle size of the inorganic particles is within the above ranges, a molded body which is excellent in both scratch resistance and transparency can be provided.

In a case where the inorganic particle is a spherical shape, an average particle size (diameter) of the inorganic particles is preferably 0.01 μm or more and 10 μm or less, more preferably 0.3 μm or more and 2 μm or less, and still more preferably 0.3 μm or more and 1.8 μm or less. In a case where the inorganic particle is not a spherical shape, an average major diameter of the inorganic particles is preferably 0.01 μm or more and 10 μm or less and more preferably more than 0.3 μm and 2 μm or less. Here, the “major diameter” refers to a length of the longest part of the particle in a straight distance. The average major diameter and the average particle size can be measured by reading an image of the particle observed with a scanning electron microscope. When the average major diameter or the average particle size of the inorganic particles is within the above ranges, a molded body which is excellent in both scratch resistance and transparency can be provided.

An example of the inorganic particle can include at least one selected from the group consisting of a silica (SiO₂) particle, a silica composite oxide particle, an alumina (Al₂O₃) particle, a titania (TiO₂) particle, and a glass filler particle.

The silica composite oxide refers to a material in which a part of a silicon (Si) element in silica is substituted with another element, that is, a material in which silicon forms an oxide having a uniform structure together with another element. A structure of the silica composite oxide can be analyzed by an X-ray absorption fine structure (XAFS) spectrum.

The other element is an element other than silicon and oxygen, and is not particularly limited as long as the other element can form an oxide having a uniform structure together with silicon. Examples of the other element can include elements from Group 2 to Group 14, and preferably, titanium, zirconium, aluminum, zinc, chromium, manganese, magnesium, cerium, boron, iron, indium, and tin. In more preferred aspect, the other element is titanium, zirconium, or aluminum and more preferably titanium.

That is, in an aspect, the silica composite oxide can be a silica-titania composite oxide, a silica-zirconia composite oxide, or a silica-alumina composite oxide, preferably a silica-titania composite oxide or a silica-zirconia composite oxide, and more preferably a silica-titania composite oxide.

In an aspect, a content of the other element contained in the silica composite oxide particles is preferably 0.01 to 10 mol %, and more preferably 0.1 to 5 mol %, with respect to all of atoms of the silica composite oxide. The content of the other element contained in the silica composite oxide can be measured by an ICP-AES method, an SEM-EDX method, a TEM-EDX method, or the like.

The silica composite oxide particle preferably has a refractive index of 1.47 or more and 1.60 or less, more preferably 1.48 or more and 1.52 or less, and still more preferably 1.49 or more and 1.51 or less. When the refractive index of the silica composite oxide particle is within these ranges, a molded body formed of a resin composition having high transparency can be obtained. Here, in the present specification, the refractive index refers to a refractive index of light with a wavelength of 589 nm measured at 25° C.

A difference between a refractive index of the thermoplastic resin and a refractive index of the silica composite oxide particle when light with a wavelength of 589 nm is irradiated at 25° C. is preferably 0.03 or less, more preferably 0.02 or less, and still more preferably 0.01 or less. It is particularly preferable that both refractive indices are the same as each other. When the difference between both refractive indices is 0.03 or less, a molded body formed of a resin composition having high transparency can be obtained. When the difference between both refractive indices is made small, a molded body having higher transparency can be obtained.

The refractive index of the thermoplastic resin can be measured using a critical angle method, a V block method, a liquid immersion method, or the like. In addition, the refractive index of the silica composite oxide particle can be measured by a liquid immersion method or the like.

The silica composite oxide particle can be obtained by known methods such as a flame fusion method, a flame hydrolysis method, and a sol-gel method.

Examples of the glass filler can include glass fiber, glass beads, glass powder, and glass flakes.

The glass filler preferably has a refractive index of 1.47 or more and 1.60 or less, and more preferably 1.49 or more and 1.51 or less. When the refractive index of the glass filler is within these ranges, a molded body formed of a resin composition having high transparency can be obtained.

A difference between the refractive index of the thermoplastic resin and the refractive index of the glass filler when light with a wavelength of 589 nm is irradiated at 25° C. is preferably 0.03 or less, more preferably 0.02 or less, and still more preferably 0.01 or less. It is particularly preferable that both refractive indices are the same as each other. When the difference between both refractive indices is 0.03 or less, a molded body formed of a resin composition having high transparency can be obtained. When the difference between both refractive indices is made small, a molded body having higher transparency can be obtained.

The refractive index of the thermoplastic resin can be measured using a critical angle method, a V block method, a liquid immersion method, or the like. In addition, the refractive index of the glass filler can be measured by a liquid immersion method or the like.

For example, CF0093-01 (T1) (glass frit, average particle size: 1 μm, refractive index: 1.50) or CF0093-P5 (T4) (glass frit, average particle size: 1 μm, refractive index: 1.50) that is manufactured by Nippon Frit Co., Ltd., RXFX (8901) (glass flakes, average particle size: 40 μm, refractive index: 1.49) that is manufactured by Nippon Sheet Glass Co., Ltd., or the like can be used as the glass filler.

The thermoplastic resin structure of the present disclosure may contain an ultraviolet light absorber, an antioxidant, a release agent, an antistatic agent, a flame retardant, or the like, if necessary. Examples of the ultraviolet light absorber can include a benzophenone ultraviolet light absorber, a cyanoacrylate-based ultraviolet light absorber, a benzotriazole-based ultraviolet light absorber, a malonic acid ester-based ultraviolet light absorber, and an oxalanilide-based ultraviolet light absorber. Examples of the antioxidant can include a phenolic antioxidant, a sulfur-based antioxidant, and a phosphorus-based antioxidant. Examples of the release agent can include a higher fatty acid ester, a higher aliphatic alcohol, a higher fatty acid, a higher fatty acid amide, a higher fatty acid metal salt, and a fatty acid derivative. Examples of the antistatic agent can include a conductive inorganic particle, a tertiary amine, a quaternary ammonium salt, a cationic acrylic acid ester derivative, and a cationic vinyl ether derivative. Examples of the flame retardant can include a cyclic nitrogen compound, a phosphorus-based flame retardant, a silicon-based flame retardant, a cage-like silsesquioxane or a partially cleaved structure thereof, and a silica-based flame retardant.

The thermoplastic resin structure of the present disclosure may contain a coloring agent such as a dye or a pigment. Although transparency is impaired by containing the coloring agent, the thermoplastic resin structure of the present disclosure has excellent coloring property and can thus be colored in various colors. Examples of the coloring agent can include a perylene-based dye, a perinone-based dye, a pyrazolone dye, a methine-based dye, a coumarin dye, a quinophthalone-based dye, a quinoline-based dye, an anthraquinone-based dye, an anthraquinone-based dye, an anthrapyridone-based dye, a thioindigo-based dye, a coumarin-based dye, an isoindolinone-based pigment, a diketo-pyrrolo-pyrrole-based pigment, a condensed azo-based pigment, a benzimidazolone-based pigment, a dioxazine-based pigment, a copper phthalocyanine-based pigment, a quinacridone-based pigment, a nickel complex-based compound, zinc stearate, magnesium stearate, calcium stearate, aluminum stearate, polymethylsilsesquioxane, halogenated copper phthalocyanine, ethylene bis-stearic acid amide, ultramarine blue, ultramarine violet, Ketjen Black, acetylene black, furnace black, carbon black, liquid paraffin, and silicone oil.

The thermoplastic resin structure of the present disclosure satisfies the following (1) and (2).

(1) A content of inorganic particles in the structure is less than 0.8 parts by mass with respect to 100 parts by mass of a thermoplastic resin.

(2) An area ratio of the inorganic particles on at least one surface of the structure is 0.5% or more, the area ratio being defined by π/4×r² N/S (r=d+3σ), in which the number of inorganic particles identified from image analysis of an SEM image of the surface of the structure is N number/μm², an average circle-equivalent diameter of the particles is d μm, a standard deviation of the average circle-equivalent diameter is σ μm, and a visual field area is S μm².

(Condition 1)

The content of the inorganic particles in the thermoplastic resin structure of the present disclosure is less than 0.8 parts by mass with respect to 100 parts by mass of the thermoplastic resin. When the condition is satisfied, that is, the content of the inorganic particles in the thermoplastic resin structure is less than 0.8 parts by mass with respect to 100 parts by mass of the thermoplastic resin, a structure having high transparency can be obtained.

The content of the inorganic particles is preferably 0.1 parts by mass or less, more preferably 0.03 parts by mass or less, still more preferably 0.027 parts by mass or less, and further still more preferably 0.009 parts by mass or less, with respect to 100 parts by mass of the thermoplastic resin. When the content of the inorganic particles in the thermoplastic resin structure is further reduced, a structure having higher transparency can be obtained.

In addition, the content of the inorganic particles in the thermoplastic resin structure of the present disclosure is preferably 0.0010 parts by mass or more, more preferably 0.0016 parts by mass or more, and still more preferably 0.003 parts by mass or more, with respect to 100 parts by mass of the thermoplastic resin. When the content of the inorganic particles in the thermoplastic resin structure is 0.0010 parts by mass or more with respect to 100 parts by mass of the thermoplastic resin, a structure having higher scratch resistance can be obtained. In addition, when the content of the inorganic particles in the thermoplastic resin structure is further increased, a structure having higher scratch resistance can be obtained.

The content of the inorganic particles in the thermoplastic resin structure can be measured using an inductively coupled plasma-atomic emission spectrometry (ICP-AES) method. For example, in a case where the inorganic particle is silica, a structure to be measured is formed into a 3 mm-thick sheet, and a weight of a silicon element in a test piece cut into 1 cm squares is quantified using an ICP-AES method. A quantitative value of the silicon element is defined as A (unit: ppm), and B (unit: ppm) expressed by the following equation is defined as a silica concentration.

B=A×60/28

(In the equation, 60 is a formula weight of silica, and 28 is an atomic weight of silicon.)

In a case where the inorganic particle is silica-titania, a structure to be measured is formed into a 3 mm-thick sheet, and weights of a silicon element and a titanium element in a test piece cut into 1 cm squares are quantified using an ICP-AES method. There is also a case where the silicon element, the titanium element, and the oxygen element are uniformly dispersed in the silica-titania, but for convenience, a silica concentration and a titania concentration are calculated, individually, and a total value thereof can be defined as a silica-titania concentration. That is, a quantitative value of the silicon element is defined as A (unit: ppm), and B (unit: ppm) expressed by the following equation is defined as a silica concentration.

B=A×60.1/28.1

(In the equation, 60 is a formula weight of silica, and 28 is an atomic weight of silicon.)

In addition, a quantitative value of the titanium element is defined as C (unit: ppm), and D (unit: ppm) expressed by the following equation is defined as a titania concentration.

D=C×79.9/47.9

(In the equation, 79.9 is a formula weight of titania, and 47.9 is an atomic weight of titanium.)

A total value of B and D is defined as a silica-titania concentration.

(Condition 2)

The area ratio of the inorganic particles on at least one surface of the thermoplastic resin structure of the present disclosure is 0.5% or more. Here, the area ratio of the inorganic particles is defined by the following equation.

Area ratio of inorganic particles=π/4×r²N/S

(In the equation:

r=d+3σ,

in which N is the number of inorganic particles per unit area (number/μm²) identified from image analysis of an SEM image of the surface of the structure,

d is an average circle-equivalent diameter (μm) of the inorganic particles,

σ is a standard deviation (μm) of d, and

S is a visual field area (μm²) of the SEM image.)

When the condition is satisfied, that is, the area ratio of the inorganic particles on at least one surface of the thermoplastic resin structure is 0.5% or more, a structure having high scratch resistance can be obtained.

The area ratio of the inorganic particles is preferably 0.8% or more, more preferably 2% or more, still more preferably 3% or more, further still more preferably 10% or more, particularly preferably 20% or more, and further particularly preferably 25% or more. When the area ratio of the inorganic particles is further increased, a structure having higher scratch resistance can be obtained.

In addition, the area ratio of the inorganic particles in the thermoplastic resin structure of the present disclosure is preferably 80% or less, more preferably 50% or less, and still more preferably 30% or less. When the area ratio of the inorganic particles is further reduced, a structure having higher transparency can be obtained.

In an aspect, in the thermoplastic resin structure of the present disclosure, an area ratio of the inorganic particles on one surface is 0.5% or more and preferably 2% or more, and an area ratio of the inorganic particles on a surface facing the one surface is 0.1% or less and preferably 0.01% or less.

The thermoplastic resin structure of the present disclosure has high transparency because the content of the inorganic particles in the entire structure is small. In addition, since the area ratio of the inorganic particles on at least one surface of the thermoplastic resin structure of the present disclosure is 0.5% or more, the surface has high scratch resistance.

In an aspect, in the thermoplastic resin structure of the present disclosure, a haze measured according to JIS K7136 is 4% or less, preferably 3% or less, and more preferably 1% or less.

In an aspect, a Δ haze of the thermoplastic resin structure of the present disclosure is less than 1.0%, preferably 0.5% or less, and more preferably 0.1% or less. Here, a haze (%) is obtained when #0000 steel wool is pressed against a plate surface (the surface is a surface having the area ratio of the inorganic particles of 0.5% or more) of the thermoplastic resin structure at a pressure of 14 kPa, and the steel wool is rubbed forward and backward at a rate of 15 cm/sec in a direction perpendicular to a fiber direction of the steel wool 11 times, and the Δ haze is a variation of the haze (%) to an initial haze (%).

A method of measuring the haze according to JIS K7136 is as follows.

### INTRODUCTION

The standards are the Japanese Industrial Standards created by translating ISO14782, Plastics-Determination of haze for transparent materials, issued as the first edition in 1999 without changing the technical contents and the specification table formats.

### 1. Application Range

The standard specifies how to calculate a haze which is a specific optical property related to wide-angle scattering of light in transparent and basically colorless plastic. A test method thereof can be applied to a material having a haze value of 40% or less, the haze value being measured by the method.

### 2. Definition

The haze refers to a percentage of transmitted light which is shifted from incident light at 0.044 rad (2.5°) or larger by forward scattering to transmitted light which is transmitted through a test piece.

### 3. Device

3-1. A device consists of a stable light source, a connection optical system, an integrating sphere provided with openings, and a photometer, and the photometer consists of a light receiver, a signal processing device, and a display device or a recorder (see FIG. 3).

3-2. Properties of a combination of the light source and the photometer to be used after passing through a filter are required to provide a photopic vision standard luminous efficiency V (λ) (defined by IEC60050-845) equal to a color matching function y (λ) according to ISO/CIE10527 and an output corresponding to a combination of CIE standard light D65 defined by ISO/CIE10526. An output of the photometer is required to be proportional to luminous flux of incident light within 1% in a range of luminous flux to be used. It is desirable that spectral characteristics and photometric characteristics of the light source and the photometer be kept constant during the measurement.

3-3. The light source is combined with an optical system to obtain parallel luminous flux. A maximum angle between any light included in the luminous flux and an optical axis is required not to exceed 0.05 rad (3°). The luminous flux is required to be clear at any opening of the integrating sphere.

3-4. The device is required to be designed so that a read value is constant in a case where the luminous flux is absent.

3-5. The integrating sphere is used for condensing transmitted luminous flux. A diameter of the integrating sphere may be any value as long as a total area of the openings does not exceed 3.0% of an area of an inner surface of the integrating sphere. The diameter of the integrating sphere is desirably 150 mm or more so that a large sample can be measured.

3-6. The integrating sphere has an inlet opening, an outlet opening, a compensation opening, and a light receiving opening (see FIG. 3). The centers of the inlet and outlet openings are on the same great circle of the sphere, and a central angle of a circular arc on the great circle corresponding to the centers of these openings is 3.14 rad±0.03 rad (180±2°). An angle formed by a diameter of the outlet opening and the center of the inlet opening is 0.140 rad±0.002 rad (8±0.1°). The outlet opening and the compensation opening have the same size. The inlet opening, the compensation opening, and the light receiving opening are required not to be on the same great circle of the integrating sphere. The compensation opening is located at a position at which a central angle with the inlet opening is within 1.57 rad (90°).

3-7. In a case where a sample is not placed at the inlet opening, a cross section of luminous flux at the outlet opening is required to be approximately circular and clear, and an annular part is required to remain around the outlet opening at a concentric circle with the outlet opening. An angle formed by the annular part and the center of the inlet opening is 0.023 rad±0.002 rad (1.3°±0.10).

3-8. A light shielding plate is attached to the integrating sphere so that light passed through the sample is not directly detected by the light receiver. The light receiver has a central angle of 1.57 rad±0.26 rad (90°±15°) from the inlet opening on the integrating sphere. Light traps placed at the outlet opening and the compensation opening are required to completely absorb light when the sample is absent, or the device is required to be designed so that light traps at the outlet opening and the compensation opening are not required.

3-9. Y₁₀ of tristimulus values of the inner surface, the light shielding plate, and a reference white plate (in general, the inner surface, the light shielding plate, and the reference white plate are supplied from a manufacturer of the device) of the integrating sphere calculated according to ISO772-2 is required to be 90% or more and a variation thereof is required to be within a range of ±3%. In a case where a reflectance on the inner surface of the integrating sphere is difficult to directly measure, a surface separately prepared under the same materials and the same conditions as those of the inner surface may be measured.

3-10. A test piece holder fixes the test piece to the luminous flux at a right angle within ±2°, and the test piece is attached as close to the integrating sphere as possible so that total transmitted light including diffused light can be captured. In addition, the holder can hold a flexible test piece flat. Both ends of a thin and flexible film may be interposed between double ring holders or may be attached to an end of the holder using a double-sided adhesive tape. A thick test piece that cannot be attached to a double ring holder is also used in the latter method. The test piece may be attached to a sample stand using a vacuum pump or a vacuum suction plate.

### 4. Test Piece

4-1. The test piece is cut out from a film, a sheet, or a molded article obtained by injection molding or compression molding.

4-2. It is required that in the test piece, defects, dust, grease, an adhesive from a protective material, scratches, and debris are absent, and visible voids or foreign matters are absent.

4-3. The test piece has a size enough to cover the inlet opening and the compensation opening of the integrating sphere. The test piece may be a disk having a diameter of 50 mm or a square having a side of 50 mm.

4-4. Unless otherwise specified, three test pieces are prepared for each sample of a test material.

### 5. State Adjustment

5-1. If necessary, a state of the test piece is adjusted under conditions of a temperature of (23±2°) C and a relative humidity of (50±10)% according to ISO291 before the test for 40 hours or longer.

5-2. If necessary, a test device is installed in an atmosphere maintained at a temperature of (23±2°) C and a relative humidity of (50±10)%.

### 6. Procedure

6-1. The test device is made to reach thermal equilibrium for a sufficient period of time before the test.

6-2. The test piece is attached to the test piece holder.

6-3. Four values (τ1, τ2, τ3, and τ4) shown in the following table are read from a meter.

6-4. A thickness of the test piece is measured at three locations, and is accurately measured up to 0.02 mm in a case of a sheet and 1 μm in a case of a film.

6-5. The above procedures are sequentially performed for the three test pieces.

| | | | Compensation |
|---|---|---|---|
| | Inlet opening | Outlet opening | opening |
| τ1 | | Reference white | Light trap |
| | | plate | |
| τ2 | Test piece | Reference white | Light trap |
| | | plate | |
| τ3 | | Light trap | Reference white |
| | | | plate |
| τ4 | Test piece | Light trap | Reference white |
| | | | plate |

* Referring to note of 7

### 7. Calculation

The haze (%) is calculated by the following equation.

Haze=[(τ4/τ2)−τ3(τ2/τ1)]×100

τ1: Luminous flux of incident light

τ2: Total luminous flux transmitted through test piece

τ3: Luminous flux diffused in device

τ4: Luminous flux diffused in device and test piece

Reference: In order to accurately calculate a total light transmittance using a single beam device, the test piece is required to be placed at the compensation opening instead of the light trap (as defined in ISO13468-1). This is for canceling a change in efficiency of the integrating sphere. As another method, a measurement value can be corrected and calculated by using a standard test piece calibrated by a double beam device. However, since there is almost no difference in the obtained haze values, it is practically sufficient to use τ1 obtained by placing the light trap at the compensation opening instead of the test piece.

A thickness of the thermoplastic resin structure of the present disclosure is preferably 0.3 to 100 mm, more preferably 0.5 to 20 mm, still more preferably 1 to 10 mm, and further still more preferably 1 to 5 mm. When the thickness of the thermoplastic resin structure is within these ranges, a structure excellent in strength and transparency can be obtained.

In an aspect, the thickness of the thermoplastic resin structure of the present disclosure is 0.3 to 100 mm, more preferably 0.5 to 20 mm, and still more preferably 1 to 10 mm, and further still more preferably 1 to 5 mm, and the haze measured according to JIS K7136 is 4% or less, preferably 3% or less, and more preferably 1% or less. In a preferred aspect, the thickness of the thermoplastic resin structure of the present disclosure is 1 to 5 mm, and the haze measured according to JIS K7136 is 3% or less and preferably 1% or less.

In an aspect, in the thermoplastic resin structure of the present disclosure, the inorganic particles are unevenly distributed on at least one surface side of the thermoplastic resin structure. The inorganic particles are unevenly distributed from the surface of the thermoplastic resin structure to preferably a depth of 100 μm, to more preferably a depth of 20 μm, to still more preferably a depth of 10 μm, and to further still more preferably a depth of 5 μm. In other words, in the thermoplastic resin structure, a thickness of a region in which the inorganic particles are present is preferably 100 μm or less, more preferably 20 μm or less, still more preferably 10 μm or less, and further still more preferably 5 μm or less. Here, the “unevenly distributed” refers to that the inorganic particles in the thermoplastic resin structure of the present disclosure are present in an amount of preferably 80 mass % or more, more preferably 90 mass % or more, still more preferably 95 mass % or more, and particularly preferably 98 mass % or more, and most preferably, substantially all of the inorganic particles are present in a predetermined range.

In an aspect, the thermoplastic resin structure of the present disclosure has a single layer structure. Here, the “single layer structure” refers to a structure having no interface by lamination in the layer. In the present disclosure, even though compositions of an upper part and a lower part of the layer are completely different from each other, when both compositions are continuously changed in the layer, it is regarded as a single layer structure.

In the aspect, in the thermoplastic resin structure of the present disclosure, the inorganic particles are preferably unevenly distributed on at least one surface side. In particular, in a cross section of the thermoplastic resin structure, the largest amount of the inorganic particles are present on a surface of one face, and the amount of the inorganic particles is continuously reduced as distance from the inner portion decreases (that is, as close to an opposite side).

In an aspect, the thermoplastic resin structure of the present disclosure has a multilayer structure. That is, the thermoplastic resin structure of the present disclosure can be a laminated body. Here, the “multilayer structure” refers to a structure having an interface formed by lamination in the layer.

In the aspect, in the thermoplastic resin structure of the present disclosure, the inorganic particles are preferably present in only one outermost layer.

In an aspect, the thermoplastic resin structure of the present disclosure does not have a coating layer formed of a curable resin composition. The thermoplastic resin structure has no coating layer, such that wrinkles can be prevented from occurring during processing.

The coating layer refers to a layer having no film-like insoluble matter when the structure is immersed in chloroform. In other words, when the thermoplastic resin structure of the aspect is immersed in chloroform, a film-like insoluble matter is not produced.

A shape of the thermoplastic resin structure of the disclosure is not particularly limited, and may be determined depending on an application. For example, the shape of the thermoplastic resin structure can be a film shape, a sheet shape, a plate shape, a block shape, or the like. In addition, in an aspect, the shape of the thermoplastic resin structure can be a shape of a vehicle exterior material such as a lamp cover for a vehicle, a visor, or a front grill, a vehicle interior material such as a meter cover or an in-vehicle display front plate, a building material such as a window or a sound insulation wall, a signboard, furniture such as a table top, a display shelf, an exterior such as a carport, a display front plate, or a lighting fixture component such as a cover or a glove.

As described above, since the thermoplastic resin structure of the present disclosure can have high scratch resistance and further can have high transparency, the thermoplastic resin structure is appropriately used as a vehicle exterior material such as a lamp cover for a vehicle, a visor, or a front grill, a vehicle interior material such as a meter cover or an in-vehicle display front plate, a building material such as a window or a sound insulation wall, a signboard, furniture such as a table top, a display shelf, an exterior such as a carport, a display front plate, or a lighting fixture component such as a cover or a glove. Therefore, the present disclosure includes a vehicle exterior material such as a lamp cover for a vehicle, visor, or front grill, a vehicle interior material such as a meter cover or an in-vehicle display front plate, a building material such as a window or a sound insulation wall, a signboard, furniture such as a table top, a display shelf, an exterior such as a carport, a display front plate, and a lighting fixture component such as a cover or a glove that include the thermoplastic resin structure of the present disclosure.

Examples of the lamp cover for a vehicle can include covers of a headlight, a taillight, a brake light (stop lamp), a turn signal light (winker), a fog lamp, a vehicle width lamp, and a reversing light. A molded body and a laminated body of the present disclosure can be appropriately used as a cover of a headlight, that is, a headlight cover which is frequently rubbed by gravel or the like and is required to have more excellent scratch resistance.

In the molded body and the stacked body of the present disclosure, surface scratches other than scratches, for example, scratches caused by collision of particles such as gravel can be suppressed.

Next, a method of producing the thermoplastic resin structure of the present disclosure will be described.

The method of producing the thermoplastic resin structure of the present disclosure is not particularly limited as long as it is a method capable of providing a thermoplastic resin structure satisfying the conditions (1) and (2). For example, the thermoplastic resin structure of the present disclosure may be obtained by allowing a mixture of a raw material monomer and/or a polymer and inorganic particles to stand to precipitate the inorganic particles at a lower surface, and then performing polymerization, or may be obtained by separately preparing a layer containing inorganic particles and a layer containing no inorganic particles and laminating the layers.

In a preferred aspect, the thermoplastic resin structure of the present disclosure is produced by allowing a mixture of a raw material monomer and/or a polymer and inorganic particles to stand to precipitate the inorganic particles at a lower surface, and then performing polymerization. In such an aspect, the thermoplastic resin structure of the present disclosure is preferably produced using a cast polymerization method.

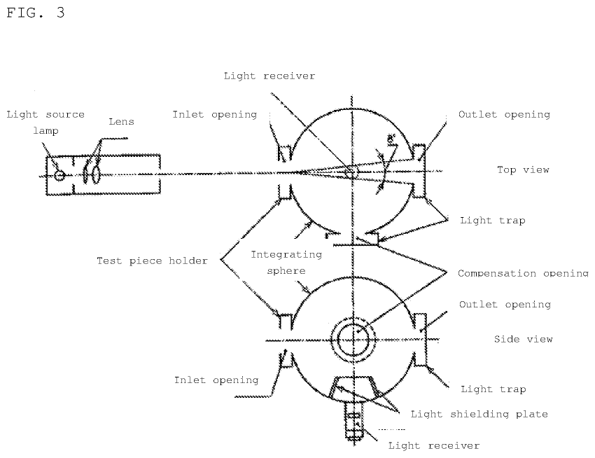

More specifically, as illustrated in FIG. 2, two support plates, and, typically, a glass plate and a gasket are prepared, and the gasket is interposed between the support plates facing each other at a predetermined distance, to form a space (hereinafter, referred to as a “cell”) into which a raw material is poured. The distance between the support plates can be appropriately prepared to obtain a structure having a desired thickness. In an aspect, the distance between the support plates is preferably 0.3 to 100 mm, more preferably 0.5 to 20 mm, still more preferably 1 to 10 mm, and further still more preferably 1 to 5 mm.

Separately, a dispersion liquid to be injected into the cell is prepared. The dispersion liquid can be obtained by mixing a liquid monomer and/or a polymer and inorganic particles with each other, deaerating, and dispersing the inorganic particles by ultrasonic waves or the like. The dispersion liquid may contain other components such as a polymerization initiator.

The obtained dispersion liquid is injected into the cell and is allowed to stand with one support plate positioned on a perpendicular lower side and the other support plate positioned on a perpendicular upper side. The dispersion liquid is allowed to stand under a condition in which polymerization of the monomer and/or the polymer is not initiated until the inorganic particles in the dispersion liquid in the vicinity of the support plate are precipitated at a desired density. In order to obtain a thermoplastic resin structure having excellent scratch resistance, it is preferable that the inorganic particles in the dispersion liquid in the vicinity of the support plate are increased, and the dispersion liquid may be allowed to stand until the dispersion liquid reaches a steady state. In a case where production efficiency is prioritized, a time required for production is preferably short, and the dispersion liquid may be allowed to stand for a shorter period of time than when the dispersion liquid reaches the steady state. In order to achieve the desired density, a viscosity and a standing time of the dispersion liquid may be selected.

After the standing, a thermoplastic resin structure of the present disclosure can be obtained by polymerizing the monomer and/or the polymer. Polymerization conditions can be appropriately set depending on a raw material to be used.

In the thermoplastic resin structure obtained by the above method, the precipitated inorganic particles are unevenly distributed on one surface side.

### EXAMPLES

Hereinafter, a resin composition of the present disclosure will be described by examples, but the content of the present disclosure is not particularly limited to these examples.

(Transparency)

A haze of an obtained molded article or laminated body was measured according to JIS K7136 (unit: %). The smaller the haze, the more excellent the transparency.

(Scratch Resistance)

A surface of the obtained molded article or laminated body was subjected to an abrasion test by steel wool. Specifically, the surface of the structure was rubbed forward and backward at a load of 14 kPa and a rate of 15 cm/sec using #0000 steel wool 11 times. The haze of the molded article or laminated body before and after the abrasion test was measured according to JIS K7136, and a variation of the haze (A haze (unit: %)) before and after the test was calculated. The smaller the A haze, the more excellent the scratch resistance.

(Concentration of Inorganic Particles Contained in Entire Layer)

Weights of a silicon element and a titanium element in a test piece obtained by cutting a sheet to be measured into 1 cm squares were quantified using an ICP-AES method. A quantitative value of the silicon element was defined as A (unit: ppm), and B (unit: ppm) expressed by the following equation was defined as a silica concentration.

B=A×60/28

60 is a formula weight of silica, and 28 is an atomic weight of silicon.

In addition, a quantitative value of the titanium element was defined as C (unit: ppm), and D (unit: ppm) expressed by the following equation was defined as a titania concentration.

D=C×79.9/47.9

79.9 is a formula weight of titania, and 47.9 is an atomic weight of titanium.

When silica-titania was used as the inorganic particle, a total value of B and D was defined as a concentration of the inorganic particles.

(Surface Inorganic Particle Area Ratio)

A surface of the sheet to be evaluated was enlarged at a magnification of 1,000× with a scanning electron microscope to obtain an enlarged image of a field of view of 130 μm×90 μm. An area S μm² was calculated from a magnitude of the field of view. A contrast of the obtained image was binarized, the number of each particle was calculated, and the number N of present inorganic particles per unit area (unit: number/μm²) was calculated. In addition, a radius of a circle having an area corresponding to an average of an area of the particles was calculated as an average circle-equivalent diameter d (unit: μm). Furthermore, a standard deviation σ of d was calculated and π/4×r² N/S when r=d+3σ was calculated as a surface silica area ratio. WinROOF manufactured by MITANI CORPORATION was used for image analysis.

(Heat-Bending Test)

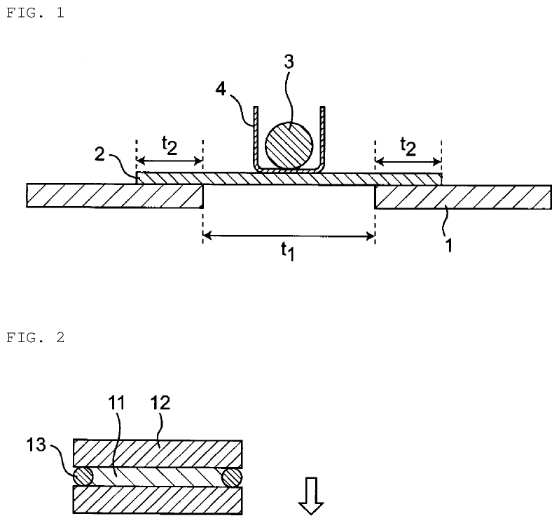

The sheet to be evaluated was cut into 70 mm×120 mm and used as a measurement sample. As illustrated in FIG. 1, a sample 2 was installed on stands 1 with an interval t₁ of 80 mm so that the sample 2 was placed on the stand 1 with a width t₂ of 20 mm from an end of the sample 2, and a disposable cup 4 into which 620 g of a weight 3 was input was placed at the central portion of the sample. Thereafter, the sample was heated to 110° C., the heating was stopped at the point in time at which the disposable cup was lowered by 10 mm from an initial position due to bending of the sample, and then the presence or absence of wrinkles on the surface was visually observed. No wrinkles means that heat bendability is excellent. In this case, in a case where there was a difference in hardness between a vertical upper surface and a vertical lower surface of the measurement sample, a surface having higher hardness was directed to the vertical upper surface and tested. In a case of an acrylic plate, a heating temperature was preferably 110° C., but in a case of other base materials, the same evaluation for searching for a condition in which the disposable cup is lowered by 10 mm from the initial position can be performed at appropriately different temperatures.

(Dissolution Test)

The presence or absence of film-like insoluble matters when the sheet to be evaluated was immersed in chloroform and allowed to stand at 23° C. for 1 week was visually observed. A case where the film-like insoluble matters are present means that the sheet is coated.

(Cup Viscosity)

An unheated monomer and/or polymer used in cast polymerization was used as a sample, and the time required for the sample to pass through a cylinder having a truncated cone shape according to the following procedure was defined as a cup viscosity. A cylinder having an upper surface inner diameter of 37 mm, a lower surface inner diameter of 5 mm, and a height of 65 mm was used as the cylinder having the truncated cone shape.

A specific procedure will be described below. The sample is poured into a cylindrical beaker having an inner diameter of 100 mm and a height of 110 mm until a height of a liquid level reaches 80 mm or higher, and the cylinder having the truncated cone shape is immersed to be lower than the liquid level of the sample, thereby filling the cylinder having the truncated cone shape with the sample. Thereafter, the cylinder having the truncated cone shape is pulled up vertically so that the cylinder is higher than the liquid level of the sample in the beaker. The time from the moment of pulling up until the sample in the cylinder having the truncated cone shape flows is measured and defined as a cup viscosity (unit: second).

(Used Inorganic Particles)

Silica particle, Admafine (registered trademark) SO-C2 (average particle size: 0.5 μm), manufactured by Admatechs Company Limited

Silica particle, Admafine (registered trademark) SO-C5 (average particle size: 1.5 μm), manufactured by Admatechs Company Limited

Silica-titania SiTi0849 (average particle diameter: 0.8 μm, refractive index: 1.49)

(Dispersibility of Inorganic Particles)

5 parts by mass of SO-C2 was mixed with 95 parts by mass of methyl methacrylate, and the mixture was dispersed with ultrasonic waves. The mixture was allowed to stand for 30 minutes to precipitate SO-C2 at the bottom.

### Example 1

<Cast Polymerization>

In a glass vessel, 0.08 parts by mass of sodium di-(2-ethylhexyl) sulfosuccinate, 0.01 parts by mass of terpinolene, and 0.08 parts by mass of 2,2′-azobisisobutyronitrile were dissolved in 100 parts by mass of methyl methacrylate, and 0.003 parts by mass of SO-C2 was added. In this case, a cup viscosity of the methyl methacrylate was 1.6 seconds. Deaeration was performed by reduced pressure, and then an inorganic particle dispersion liquid in which silica particles were dispersed with ultrasonic waves was adjusted. An inorganic particle dispersion liquid 11 was injected into the cell configured by interposing a 3.8 mm-thick vinyl chloride resin gasket 13 between two glass plates 12 as in FIG. 2, the glass plates were placed in an oven so that one glass plate was placed on a vertical lower side (the arrow direction in FIG. 2) and the other glass plate was placed on a vertical upper side, and the inorganic particle dispersion liquid was allowed to stand at room temperature for 30 minutes. Thereafter, the heating was performed according to the following conditions, and the inorganic particle dispersion liquid was polymerized, to obtain a 3 mm-thick acrylic plate.

(Heating Condition)

Step 1: Heating from room temperature to 72° C. over 30 minutes

Step 2: Holding at 72° C. for 70 minutes

Step 3: Cooling from 72° C. to 68° C. over 20 minutes

Step 4: Holding at 68° C. for 60 minutes

Step 5: Heating from 68° C. to 120° C. over 30 minutes

Step 6: Holding at 120° C. for 40 minutes

Step 7: Cooling from 120° C. to room temperature over 75 minutes

Evaluation results of the obtained acrylic plate are shown in Table 1. The surface placed on the vertical lower side in the oven was used as an evaluation surface.

### Example 2

An acrylic plate was obtained in the same manner as that of Example 1 except that 0.03 parts by mass of SO-C2 was added. The evaluation results are shown in Table 1. The surface placed on the vertical lower side in the oven was used as an evaluation surface.

### Comparative Example 1

<Production of Methacrylic Resin A>

To a polymerization reactor equipped with a stirrer, a mixture of 97.5 parts by mass of methyl methacrylate and 2.5 parts by mass of methyl acrylate, 0.016 parts by mass of 1,1-di(tert-butylperoxy)cyclohexane, and 0.16 parts by mass of n-octyl mercaptan were continuously fed, and a polymerization reaction was performed at 175° C. for an average retention time of 43 minutes. Next, a reaction solution (partial polymer) discharged from the polymerization reactor was preheated and then fed to a devolatilization extruder, and an unreacted monomer component was vaporized and recovered, to obtain a pellet-like methacrylic resin A. In the obtained methacrylic resin A, a content of a monomer unit derived from the methyl methacrylate was 97.5 wt %, a content of a monomer unit derived from the methyl acrylate was 2.5 wt %, and an MFR was 2 g/10 min.

<Melting and Kneading>

0.03 parts by mass of SO-C2 was mixed with 100 parts by mass of the methacrylic resin A, the mixture was melted and kneaded under the following kneading conditions to extrude the mixture into a strand shape using a twin screw extruder (model: TEX30SS-30AW-2V) manufactured by Japan Steel Works, Ltd., and the mixture was cooled and cut by a strand cutter, to obtain a pellet-like methacrylic resin composition.

(Kneading Condition)

Extruder temperature: In eight heaters from a raw material inlet to an outlet, 200° C., 200° C., 210° C., 220° C., 230° C., 240° C., 240° C., and 250° C. were set, respectively, from a raw material inlet side.

Rotation speed: 200 rpm

Input rate of raw material: 12 kg/hr

<Injection Molding>

The obtained pellet-like methacrylic resin composition was molded into a 150 mm×90 mm×3 mm-thick plate shape under the following molding conditions using an injection molding machine (EC130SXII-4A, manufactured by Shibaura Machine CO., LTD.), to obtain an acrylic plate.

(Molding Condition)

Screw temperature: In five heaters from a raw material inlet to an outlet, 60° C., 230° C., 240° C., 250° C., and 250° C. were set, respectively, from a raw material inlet side.

Injection rate: 90 mm/sec

Maximum injection pressure: 200 MPa

Holding pressure: 80 MPa

Mold temperature: 60° C.

Cooling timer: 45 seconds

The obtained acrylic plate was allowed to stand in an oven of 80° C. for 16 hours, and was slowly cooled to 40° C. over 4 minutes to perform each evaluation. The evaluation results are shown in Table 1. A surface on a core side of a mold during the injection molding was used as an evaluation surface.

### Comparative Example 2

An acrylic plate was obtained in the same manner as that of Comparative Example 1 except that 1 part by mass of SO-C2 was mixed with 100 parts by mass of the methacrylic resin A in the melting and kneading. The evaluation results are shown in Table 1. A surface on a core side of a mold during the injection molding was used as an evaluation surface.

### Comparative Example 3

An acrylic plate was obtained in the same manner as that of Comparative Example 1 except that SO-C2 was not added to 100 parts by mass of the methacrylic resin A in the melting and kneading. The evaluation results are shown in Table 1. A surface on a core side of a mold during the injection molding was used as an evaluation surface.

### Comparative Example 4

An acrylic plate was obtained in the same manner as that of Example 1 except that SO-C2 was not added. The evaluation results are shown in Table 1. A surface placed on the vertical lower side in the oven was used as an evaluation surface.

### Comparative Example 5

<Hard Coat>

The compositions shown in Table 2 were mixed with each other and SO-C2 was dispersed with ultrasonic waves to obtain a hard coat liquid. The hard coat liquid was applied on the acrylic obtained in Comparative Example 4 using No. 12 bar coater, and the acrylic was irradiated with ultraviolet rays so that energy per unit area was 500 mJ/cm². As a result, a 5 μm-thick hard coat layer containing a curable resin was formed. The evaluation results are shown in Table 1. A surface on which the hard coat layer was present was used as an evaluation surface.

### Comparative Example 6

20 parts by mass of a methacrylic resin (SUMIPEX (registered trademark) MM, manufactured by Sumitomo Chemical Co., Ltd.) was added to and dissolved in 80 parts by mass of methyl methacrylate. A cup viscosity of the methyl methacrylate/methacrylic resin mixture was 19 seconds. An acrylic plate was obtained in the same manner as that of Example 1, except that 100 parts by mass of the methyl methacrylate/methacrylic resin mixture was used instead of 100 parts by mass of methyl methacrylate. Evaluation results of the obtained acrylic plate are shown in Table 1. The surface placed on the vertical lower side in the oven was used as an evaluation surface.

TABLE 1

| | | Addition | | | Concentration | | | |
|---|---|---|---|---|---|---|---|---|
| | | amount of | | | of silica | Area ratio | | |
| | | SO—C2 | | | contained in | of surface | Heat- | |
| | | [parts by | Haze | Δ Haze | entire layer | silica | bending | Dissolution |
| | Molding method | mass] | [%] | [%] | [ppm] | [%] | test | test |
| Example 1 | Cast | 0.003 | 0.5 | 0.1 | 16 | 3.4 | Absence of | Absence of |
| | polymerization | | | | | | wrinkle | insoluble |
| | | | | | | | | matter |
| Example 2 | Cast | 0.03 | 2.8 | 0.1 | 270 | 26.6 | Absence of | Absence of |
| | polymerization | | | | | | wrinkle | insoluble |
| | | | | | | | | matter |
| Comparative | Injection | 0.03 | 3.5 | 5.5 | 300 | 0.4 | Absence of | Absence of |
| Example 1 | molding | | | | | | wrinkle | insoluble |
| | | | | | | | | matter |
| Comparative | Injection | 1 | 56.3 | 1.0 | 8900 | 2.2 | Absence of | Absence of |
| Example 2 | molding | | | | | | wrinkle | insoluble |
| | | | | | | | | matter |
| Comparative | Injection | 0 | 0.3 | 20 | <10 | 0 | Absence of | Absence of |
| Example 3 | molding | | | | | | wrinkle | insoluble |
| | | | | | | | | matter |
| Comparative | Cast | 0 | 0.3 | 12.3 | <10 | 0 | Absence of | Absence of |
| Example 4 | polymerization | | | | | | wrinkle | insoluble |
| | | | | | | | | matter |
| Comparative | Hard coating | — | 2.9 | 0.2 | 30 | 2.1 | Presence of | Presence of |
| Example 5 | after cast | | | | | | wrinkle | film-like |
| | polymerization | | | | | | | insoluble |
| | | | | | | | | matter |
| Comparative | Cast | 0.003 | 0.3 | 9.2 | 16 | <0.3 | Absence of | Absence of |
| Example 6 | polymerization | | | | | | wrinkle | insoluble |
| | | | | | | | | matter |

TABLE 2

| | Addition amount |
|---|---|
| Material name | [mass %] |
| Dipentaerythritol hexaacrylate | 15 |
| Pentaerythritol tetraacrylate | 15 |
| SO—C2 | 2 |
| 1-Hydroxycyclohexyl phenyl ketone | 1.125 |
| 2-Methy1-1[4-(methylthio)phenyl]-2- | 0.375 |
| morpholinopropan-1-one | |
| Leveling agent, BYK-307, manufactured by | 0.015 |
| BYK-Chemie Japan | |
| Propylene glycol monomethyl ether | 66.485 |

### Example 3

A black acrylic plate was obtained in the same manner as that of Example 2, except that 0.45 parts by mass of Sumiplast Black HB (black dye) manufactured by Sumika Chemtex Co., Ltd. was added to the inorganic particle dispersion liquid of Example 2 as an inorganic particle dispersion liquid. A surface placed on the vertical lower side in the oven was used as an evaluation surface. Since transmitted light was reduced and a haze was difficult to measure due to its black color, scratch resistance was evaluated from a change in 20° mirror surface glossiness. That is, the evaluation surface was rubbed forward and backward at a load of 14 kPa and a rate of 15 cm/sec using #0000 steel wool 11 times. The 20° mirror surface glossiness of the evaluation surface before and after the abrasion test was measured according to JIS Z8741, and a variation of the 20° mirror surface glossiness (Δ glossiness (unit: %)) before and after the test was calculated. The larger the Δ glossiness, that is, the smaller the absolute value of the Δ glossiness, the smaller the change in the glossiness, which means that scratch resistance is excellent. As a result of the measurement, the Δ glossiness was −0.5%.

### Comparative Example 7

Evaluation was performed in the same manner as that of Example 3 except that the surface was placed on the vertical upper surface in the oven as the evaluation surface. The Δ glossiness was −19.2%.

### Comparative Example 8

18 parts by mass of a methacrylic resin (SUMIPEX (registered trademark) MM, manufactured by Sumitomo Chemical Co., Ltd.) was added to and dissolved in 82 parts by mass of methyl methacrylate. A cup viscosity of the methyl methacrylate/methacrylic resin mixture was 12 seconds. An inorganic particle dispersion liquid was injected into a cell in the same manner as that of Example 1, except that 100 parts by mass of the methyl methacrylate/methacrylic resin mixture was used instead of 100 parts by mass of methyl methacrylate, and 0.003 parts by mass of SO-C5 was used instead of SO-C2. Thereafter, an acrylic plate was obtained in the same manner as that of Example 1 except that the standing time in the oven was 1 hour. Evaluation results of the obtained acrylic plate are shown in Table 3. The surface placed on the vertical lower side in the oven was used as an evaluation surface.

### Comparative Example 9

An acrylic plate was obtained in the same manner as that of Comparative Example 8 except that 0.009 parts by mass of SiTi0849 was used instead of SO-C5. Evaluation results of the obtained acrylic plate are shown in Table 3. The surface placed on the vertical lower side in the oven was used as an evaluation surface.

### Example 4

An acrylic plate was obtained in the same manner as that of Comparative Example 95 except that 0.03 parts by mass of SiTi0849 was used. Evaluation results of the obtained acrylic plate are shown in Table 3. The surface placed on the vertical lower side in the oven was used as an evaluation surface.

### Example 5

An acrylic plate was obtained in the same manner as that of Comparative Example 9 except that 0.1 parts by mass of SiTi0849 was used. Evaluation results of the obtained acrylic plate are shown in Table 3. The surface placed on the vertical lower side in the oven was used as an evaluation surface.

### Example 6

An acrylic plate was obtained in the same manner as that of Comparative Example 9 except that the standing time in the oven was 20 hours. Evaluation results of the obtained acrylic plate are shown in Table 3. The surface placed on the vertical lower side in the oven was used as an evaluation surface.

TABLE 3

| | | | Addition | | | | | | |
|---|---|---|---|---|---|---|---|---|---|
| | | | amount of | | | Concentration | | | |
| | | | inorganic | | | of silica | Area ratio | | |
| | | | particle | | | contained in | of surface | Heat- | |
| | | Inorganic | [parts by | Haze | Δ Haze | entire layer | silica | bending | Dissolution |
| | Molding method | particle | mass] | [%] | [%] | [ppm] | [%] | test | test |
| Comparative | Cast | SO—C5 | 0.003 | 0.5 | 2.5 | 30 | 0.2 | Absence of | Absence of |
| Example 8 | polymerization | | | | | | | wrinkle | insoluble |
| | | | | | | | | | matter |
| Comparative | Cast | SiTi0849 | 0.009 | 0.2 | 2.1 | 90 | 0.1 | Absence of | Absence of |
| Example 9 | polymerization | | | | | | | wrinkle | insoluble |
| | | | | | | | | | matter |
| Example 4 | Cast | SiTi0849 | 0.03 | 0.3 | 0.6 | 300 | 0.8 | Absence of | Absence of |
| | polymerization | | | | | | | wrinkle | insoluble |
| | | | | | | | | | matter |
| Example 5 | Cast | SiTi0849 | 0.1 | 0.9 | 0.4 | 760 | 0.5 | Absence of | Absence of |
| | polymerization | | | | | | | wrinkle | insoluble |
| | | | | | | | | | matter |
| Example 6 | Cast | SiTi0849 | 0.009 | 0.2 | 0.3 | 60 | 2.5 | Absence of | Absence of |
| | polymerization | | | | | | | wrinkle | insoluble |
| | | | | | | | | | matter |

### INDUSTRIAL APPLICABILITY

The structure of the present disclosure can be appropriately used as an application required to have transparency and scratch resistance, for example, a vehicle exterior material such as a lamp cover for a vehicle, visor, or front grill, a vehicle interior material such as a meter cover or an in-vehicle display front plate, a building material such as a window or a sound insulation wall, a signboard, furniture such as a table top, a display shelf, an exterior such as a carport, a display front plate, or a lighting fixture component such as a cover or a glove.

1. A thermoplastic resin structure satisfying the following (1) and (2):
(1) a content of inorganic particles in the structure is less than 0.8 parts by mass with respect to 100 parts by mass of a thermoplastic resin, and the inorganic particles include at least one selected from the group consisting of a silica particle, a silica composite oxide particle, an alumina particle, a titania particle, and a glass filler; and
(2) an area ratio of the inorganic particles on at least one surface of the structure is 0.5% or more, the area ratio being defined by π/4×r² N/S (r=d+3σ), in which the number of inorganic particles identified from image analysis of an SEM image of the surface of the structure is N number/μm², an average circle-equivalent diameter of the particles is d μm, a standard deviation of the average circle-equivalent diameter is σμm, and a visual field area is S μm².

2. The thermoplastic resin structure according to claim 1, wherein the area ratio of the inorganic particles on the at least one surface of the structure is 2% or more.

3. (canceled)

4. The thermoplastic resin structure according to claim 1, wherein a haze measured according to JIS K7136 is 4% or less.

5. The thermoplastic resin structure according to claim 1, wherein the thermoplastic resin includes a (meth)acrylic resin.

6. The thermoplastic resin structure according to claim 1, wherein the thermoplastic resin structure has a single layer structure.

7. A lamp cover comprising the thermoplastic resin structure according to claim 1.

8. A method of producing the thermoplastic resin structure according to claim 1, the method comprising: allowing a mixture containing a monomer and/or a polymer and inorganic particles to stand to precipitate the inorganic particles; and performing polymerization in a state where the inorganic particles are precipitated.

9. The thermoplastic resin structure according to claim 1, wherein the inorganic particles are a silica-titania composite oxide.
